(19) United States
(12) Patent Application Publication
(10) Pub. No.: US 2026/0232132 A1
(43) Pub. Date: Aug. 13, 2026

(54) COFFEE MACHINE AND METHOD OF COFFEE EXTRACTION WITH SUCH A COFFEE MACHINE

(71) Applicant: DE'LONGHI APPLIANCES S.r.l., Treviso (IT)

(72) Inventors: Paolo EVANGELISTI, Treviso (IT); Alberto ACCIARI, Treviso (IT); Nicola PIOVAN, Treviso (IT); Davide BONOTTO, Treviso (IT)

(73) Assignee: DE'LONGHI APPLIANCES S.r.l., Treviso (IT)

(21) Appl. No.: 19/474,948

(22) PCT Filed: Apr. 4, 2024
(86) PCT No.: PCT/EP2024/059162

§ 371 Date: Oct. 13, 2025

(30) Foreign Application Priority Data
Apr. 13, 2023 (IT) 102023000007122

(51) Int. Cl. A47J 31/52; A23F 5/26; A47J 31/00; A47J 31/46; A47J 31/54

(52) U.S. Cl. CPC A47J 31/5253; A23F 5/26; A47J 31/002; A47J 31/468; A47J 31/545

(57) ABSTRACT

Please replace the present Abstract with the following Abstract.

A method for extracting coffee with a coffee machine, where the machine memorizes a plurality of selectable extraction cycles, the method including among other things, detecting a temperature value along an infusion circuit, comparing the detected temperature value with an extraction start temperature value of the selected extraction cycle, performing a heat regulation step by activating the supply pump and, if necessary, the electric heater, for generating a heat regulation water flow until the detected temperature value reaches the extraction start temperature value of the selected extraction cycle, and performing the extraction step cyclically by activating the supply pump and by activating the electric heater at least when an extraction cycle is selected which envisages maintaining or increasing the extraction temperature from the extraction start temperature value.

The present invention relates to a coffee machine and a method of extracting coffee with such a coffee machine.

These are well-known automatic coffee machines capable of preparing both espresso coffee drinks obtained at high pressure and with cream formation and ‘drip’ or American coffee drinks obtained at low pressure and without cream formation.

Typically, such coffee machines are equipped with an infusion circuit featuring a water tank or connection to a water source, a water supply pump, a boiler and an infusion unit where a charge of coffee powder is placed in cascade.

The water that the pump draws from the water tank or water mains is heated by the boiler and fed to the infusion unit where it extracts the aromatic substances from the coffee powder.

For the preparation of the espresso coffee drink for the entire infusion time, the coffee charge is pressed into the infusion chamber of the infusion unit and the coffee drink coming out of the infuser passes through a valve for whip cream, the purpose of which is to increase the outlet pressure of the coffee drink so as to generate turbulence in the flow, resulting in the formation of air bubbles and foam.

For the preparation of the ‘drip’ coffee drink instead, the coffee charge is not pressed into the infusion chamber of the infusion unit for the entire infusion time, and the coffee drink coming out of the infuser by passes the brew valve.

In the coffee sector, there is a growing appreciation among consumers for other types of coffee drinks, including the so-called ‘cold brew’ or iced coffee.

Cold brew coffee is a type of drink that requires the consumer to add ice cubes to the product dispensed in the cup until the desired result is achieved.

The organoleptic properties of cold brew coffee are highly dependent on the extraction temperature and its time course during extraction.

Generally, the coffee machines on the market today for the preparation of a ‘cold brew’ coffee are not able to control the process variables, resulting in a deterioration of the organoleptic properties of the product in the cup.

Moreover, the coffee machines on the market today for the preparation of a ‘cold brew’ coffee complain of a lack of versatility of use as they are not able to customise the product dispensed.

The technical task of the present invention is to overcome the drawbacks complained of by the known technique.

Within the scope of this technical task, one purpose of the present invention is to realise a coffee extraction method and a coffee machine by means of which a variety of coffee recipes can be performed while always ensuring the desired organoleptic properties of the product in the cup.

Another purpose of the present invention is to realise a coffee extraction method and a coffee machine by means of which both espresso coffee and ‘drip’ and ‘cold brew’ coffee can be prepared. The technical task as well as this and other purposes are achieved by a method for extracting coffee with a coffee machine comprising an infusion circuit at least including a water tank or a connection to a water source, a supply pump, an electric heater and an infusion unit having an infusion chamber where a load of coffee powder can be positioned, connected in sequence, characterized in that said machine memorises a plurality of selectable extraction cycles, where each extraction cycle includes a step dedicated to the heat regulation of the infusion circuit before the positioning of the load of coffee powder and subsequently a step dedicated to the extraction of coffee having a specific coffee extraction start temperature value, where the dedicated extraction step further envisages a specific amount of coffee extracted and a specific extraction profile which envisages the repetition of identical activation cycles of the supply pump until reaching the specific amount of extracted coffee, where the cycles are each formed by an on time and an off time of the supply pump, and where the coffee machine, after having acquired a coffee extraction cycle selection, detects the temperature value along the infusion circuit, compares said detected temperature value with the extraction start temperature value of the selected extraction cycle, performs the heat regulation step by activating the supply pump and, if necessary, the electric heater, for generating a heat regulation water flow until said detected temperature value reaches said extraction start temperature value of the selected extraction cycle, and performs the extraction step cyclically by activating the supply pump and by activating the electric heater at least when an extraction cycle is selected which envisages maintaining or increasing the extraction temperature from the extraction start temperature value.

Advantageously, at least one coffee extraction cycle has an extraction start temperature value between room temperature and 50° C.

Preferably this supply pump is programmed for pulsed dispensing.

On times may be the equal or different from off times.

The invention also discloses a coffee machine configured to implement the aforementioned method for extracting coffee.

Advantageously, the invention makes it possible to control process variables, such as temperature and average flow rate delivered by the supply pump, that contribute to achieving the optimum organoleptic properties of the cup product as the selected extraction cycle varies.

The present invention also discloses a coffee machine programmed to perform the coffee extraction method.

According to the invention, it is possible to correctly execute a “cold brew” coffee extraction cycle at the desired temperature, since for this specific extraction cycle the control and regulation of the temperature of the infusion water is supplemented by the preliminary control and regulation of the temperature of the components of the infusion circuit through the heat exchange due to the flow of thermoregulation water and the control of the average flow rate delivered by the supply pump. In the preferred solution, the flow of thermoregulation water is disposed of through the outlet pipe, but it is not excluded that it may be disposed of through the infusion pipe in order to have a substantial homogenisation of the temperature along the entire hydraulic circuit before the extraction phase is carried out.

In this regard, it should also be noted that the adoption of an instantaneous boiler as an electric heater, otherwise known as a flow-through heater, greatly facilitates the achievement of the extraction start temperature with a modest amount of temperature control water.

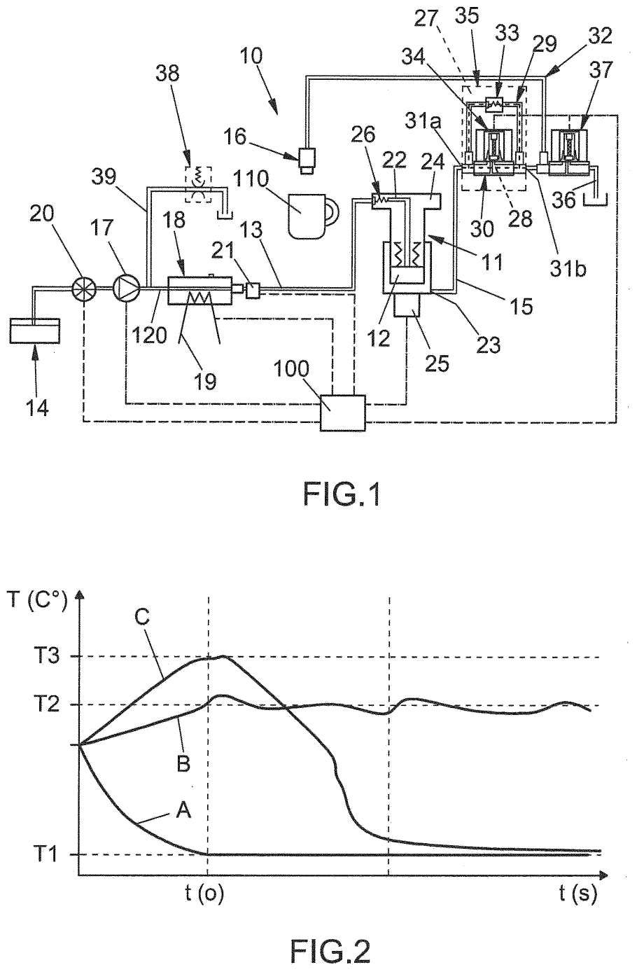

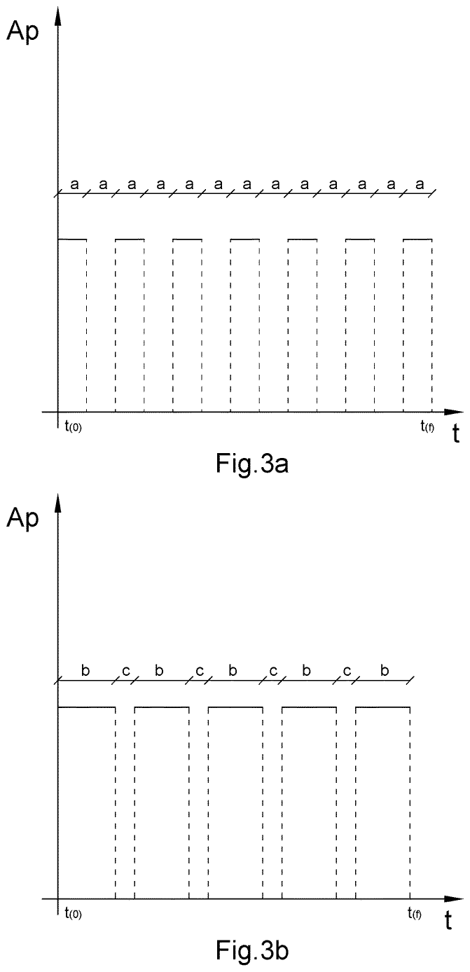

The invention will be best illustrated by the description of a preferred mode of its realisation, given by way of example but not limitation, with reference to the following attached figures:
FIG. 1 shows a diagram of the coffee machine's hydraulic circuit; and
FIG. 2 shows the temporal temperature control logic in various coffee extraction cycles; and
FIGS. 3a and 3b illustrate by way of example only some of the ways in which the supply pump can be driven in an extraction cycle.

Referring to the figures, the automatic type coffee machine 10 comprises an electronic controller 100 and an infusion circuit comprising: a source of water 14, in this case specifically a water tank, or a connection to a source of water, for example a connection to the water mains; a supply pump 17; an electric heater 18, particularly an instantaneous boiler provided with one or more electrical resistance 19; a first conduit 120 connecting a supply pump 17 outlet and an electric heater 18 inlet; an infusion unit 11 provided with an infusion chamber 12 suitable for holding a charge of coffee powder to be brewed, wherein the infusion chamber 12 has an inlet opening 22 and an outlet opening 23; a second conduit 13 connecting between an outlet of the electric heater 18 and the inlet opening 22 of the infusion unit 11; a valve assembly 35 provided with an inlet 31a and an outlet 31b; and a third connecting conduit 15 between the outlet opening 23 of the infusion chamber 12 and the inlet 31a of the valve assembly 35.

The inlet opening 22 and the outlet opening 23 of the infusion chamber 12 are preferably made one on a fixed body 24 and the other on a movable piston 25.

The infusion circuit further comprises a dispensing valve 26 located upstream of the inlet opening 22 of the infusion chamber 12, which is configured to keep the inlet opening 22 of the infusion chamber 12 closed as long as the fed water does not exceed a certain pressure value, and to open it when this value is exceeded.

As an example, dispensing valve 26 can be configured to counteract a maximum pressure of approximately 3 bar, preferably between 1 and 3 bar.

The dispensing valve 26 can also be configured to act as a non-return valve to prevent retrograde flow from the infusion chamber 12.

The valve assembly 35 located downstream of the infusion chamber 12 is configured to define a first high-pressure exit path 27 and a second low-pressure exit path 28.

The inlet 31a of the valve assembly 35 is connected to the outlet opening 23 of the infusion chamber 12, and the outlet 31b of the valve assembly 35 is connected to a dispensing conduit 32 of the beverage which in turn is connected to a dispensing nozzle 16 by means of which the coffee brew can be dispensed into a receptacle 110.

The valve assembly 35 comprises back pressure means 33 capable of providing a specified back pressure force and selectively operable bypass means 34 to bypass the action of the back pressure means 33.

In the solution illustrated by way of example, the first high-pressure path 27 and the second low-pressure path 28 are defined by a first branch 29 and a second branch 30, respectively, which are separate from each other and run between the inlet 31a and the outlet 31b.

According to this design solution, the back pressure means comprise a cream whipping valve 33 arranged along the first branch 29 and configured to allow the beverage to pass through it only if the pressure exceeds a defined threshold value.

By way of example, the cream whipping valve 33 can be configured to counteract a maximum pressure of approximately 3 bar, preferably between 1 and 3 bar.

Bypass means may include a shut-off valve 34 arranged along the second branch 30 selectively controllable to open or close a passageway and allow, or respectively prevent, the transit of drink through it.

The shut-off valve 34 can be, for example, a solenoid valve.

The coffee machine 10 also has special sensor means 21 of a temperature along the infusion circuit, preferably placed upstream or, as shown, downstream of the electric heater 18 and in particular between the electric heater 18 and the infusion unit 11.

A flowmeter 20, preferably placed upstream of the supply pump 17, can also be provided along the infusion circuit.

The machine 10 may also include a self-priming valve 38 arranged along a conduit 39 located downstream of the pump 17 and in shunt with the first connecting conduit 120.

The self-priming valve 38 can be realised as a sleeve valve, or pinch valve.

Finally, the machine 10 also includes a discharge conduit 36 for residual water from the spent coffee powder.

The discharge conduit 36 can be made as a bypass to the dispensing conduit 32 and be kept normally closed by means of an discharge electro valve 37 arranged along it.

The coffee extraction method is as follows.

The electronic controller 100 has in its memory a plurality of coffee recipes and an association to each recipe of a corresponding coffee extraction cycle that can be executed by the coffee machine. Each coffee extraction cycle advantageously comprises in sequence a dedicated phase of thermoregulation of the infusion circuit, a phase of introduction of the charge of coffee powder into the infusion chamber 12, and a dedicated phase of coffee delivery presenting a value Ti (where i=1, 2, 3, . . . ) of a temperature of start of extraction.

The electronic controller 100, after acquiring a recipe selection from the consumer, e.g. via a machine/user interface, executes the extraction cycle associated with it.

In practice, the electronic controller 100 acquires the temperature value T detected by the sensor means 21, compares the detected temperature value T with the extraction start temperature value Ti of the selected extraction cycle, and performs the thermoregulation step by activating the supply pump 17 to generate a thermoregulation water flow until the detected temperature value T reaches the extraction start temperature value Ti of the selected extraction cycle.

The thermoregulation water flows at least through the main components of the infusion circuit, in particular at least through the electric heater 18 and the infusion unit 11.

Preferably, as shown, the first connecting conduit 120, the electric heater 18, the second connecting conduit 13, the infusion unit 11, the third connecting conduit 15 and the valve assembly 35 are connected to be traversed in sequence by the flow of temperature control water.

In the solution illustrated, the flow of thermoregulation water can be discharged through the discharge conduit 36 but it is not excluded that it can be discharged through the dispensing conduit 32 in order to have a greater temperature uniformity along the infusion circuit before the start of the extraction phase.

For the execution of the thermoregulation phase, the electronic controller 100 activates the electric heater 18 to heat the thermoregulation water flow if the value T of the temperature acquired is lower than the value Ti of the extraction start temperature.

The electronic controller 100 can adjust the settings of the pump 17 and/or the electric heater 18 so that the flow of temperature control water can quickly bring the value T of the temperature detected by the sensor means 21 to the value Ti of the extraction start temperature.

When, due to the effect of the heat exchange between the flow of thermoregulation water and the components of the infusion circuit, the T value of the temperature detected by the sensor means 21 reaches the value Ti of the temperature at the start of extraction, the thermoregulation phase is terminated and the electronic controller 100 can control the execution of the phase of introduction of the charge of coffee powder into the infusion chamber 12 and subsequently the execution of the extraction phase.

Advantageously, the various selectable recipes, and the extraction cycles associated with them, can also be programmable.

Depending on the recipe, the extraction cycles may differ not only in the Ti value of the temperature at the start of extraction, but also in the time course of the temperature during the extraction phase and/or the pressure and/or water flow rate during the extraction phase.

Some extraction cycles associated with recipes that can be performed by the coffee machine are shown below.

### Case 1

The thermoregulation phase depends on the T1 value of the extraction start temperature, which in turn depends on the recipe.

The T1 value of the extraction start temperature is set at 25° C., i.e. at room temperature.

Infusion unit 11 has the infusion chamber 12 empty, having previously ejected the spent coffee powder charge.

The infusion chamber 12 then connects the second connecting conduit 13 to the third connecting conduit 15.

When it acquires the recipe and identifies the associated extraction cycle, the electronic controller 100 opens the shut-off valve 34 to allow the bypass of the cream whipping valve 33 and opens the discharge electro valve 37 to allow the water to drain.

The electronic controller 100 acquires the value T of the temperature detected by the temperature sensors means 21 and, if the acquired value T is higher than the T1 value at the start of extraction, then it keeps the electric heater 18 switched off but activates the pump 17 which draws water generally at room temperature from the water tank 14 or from the water mains so as to generate a flow of temperature control water which flows through the infusion circuit and cools it down.

Electronic controller 100 switches off pump 17 to interrupt the flow of temperature control water when it acquires a temperature value T equal to the start temperature T1.

At this point, the thermoregulation phase ends.

The electronic controller 100 does not intervene on the shut-off valve 34, which remains open, but controls the closing of the discharge electro valve 37 to connect the infusion unit 11 to the dispensing conduit 32.

The electronic controller 100 sequentially controls the opening of infusion chamber 12, the loading of the powder coffee charge, and the closing of infusion chamber 12 without compression of the powder coffee charge.

At this point, the extraction phase begins.

The electronic controller 100 controls the activation of the pump 17 and keeps the electric heater 18 switched off.

The infusion is carried out by keeping the shut-off valve 34 open and the discharge electro valve 37 closed.

Pump 17 is impulse-controlled depending on the type of flavour to be obtained, however ensuring a pressure in the region of 1 bar.

Depending on the recipe selected via the machine/user interface, an amount of ice is recommended to be added to the product in the cup.

In this way, a classic ‘cold brew’coffee can be obtained.

The extraction cycle is indicated by the letter A in FIG. 2, where the abscissa shows the time and the ordinate the temperature detected by the sensor means 21, and where to indicates the instant when the thermoregulation phase ends and the extraction phase begins.

### Case 2

Case 2 differs from case 1 in that the T2 value of the extraction start temperature is set between 25° C. and 50° C.

Infusion unit 11 has the infusion chamber 12 empty, having previously ejected the spent coffee powder charge.

The infusion chamber 12 then connects the second connecting conduit 13 to the third connecting conduit 15.

When it acquires the recipe and identifies the associated extraction cycle, the electronic controller 100 opens the shut-off valve 34 to allow the bypass of the cream whipping valve 33 and opens the discharge electro valve 37 to allow the water to drain.

The electronic controller 100 acquires the value T of the temperature detected by the temperature sensors means 21 and, if the acquired value T is lower than the T2-value at the start of extraction, then it commands the activation of the electric heater 18 as well as the pump 17 which draws water generally at room temperature from the water tank 14 or from the water mains so as to generate a flow of temperature control water which, after being heated by the electric heater 18, flows through the infusion circuit and heats it up.

The electronic controller 100 deactivates the pump 17 and electric heater 18 when it acquires a temperature value T equal to the starting temperature T2.

At this point, the thermoregulation phase ends.

The electronic controller 100 does not intervene on the shut-off valve 34, which remains open, but controls the closing of the discharge electro valve 37 to connect the infusion unit 11 to the dispensing conduit 32.

The electronic controller 100 sequentially controls the opening of infusion chamber 12, the loading of the powder coffee charge, and the closing of infusion chamber 12 without compression of the powder coffee charge.

At this point, the extraction phase begins.

The electronic controller 100 activates the pump 17 and the electric heater 18.

The infusion is carried out by keeping the shut-off valve 34 open and the discharge electro valve 37 closed.

Pump 17 is controlled by the electronic controller 100 in pulses depending on the type of aroma to be obtained, however ensuring a pressure in the region of 1 bar.

The electric heater 18 is controlled by the electronic controller 100 in such a way that the temperature detected by the sensor means 21 is substantially maintained at the T2 value during the entire extraction phase.

The extraction cycle is indicated by the letter B in FIG. 2, where to still indicates the instant at which the thermoregulation phase ends and the extraction phase begins.

### Case 3

Case 3 differs from case 1 in that the value of the extraction start temperature is set between 50° C. and 60° C.

Infusion unit 11 has the infusion chamber 12 empty, having previously ejected the spent coffee powder charge.

The infusion chamber 12 then connects the second connecting conduit 13 to the third connecting conduit 15.

When it acquires the recipe and identifies the associated extraction cycle, the electronic controller 100 opens the shut-off valve 34 to allow the bypass of the cream whipping valve 33 and opens the discharge electro valve 37 to allow the water to drain.

The electronic controller 100 acquires the value T of the temperature detected by the temperature sensors means 21 and, if the acquired value T is lower than the extraction start value, then it commands the activation of the electric heater 18 as well as of the pump 17 which draws water generally at room temperature from the water tank 14 or from the water mains so as to generate a flow of temperature control water which, after being heated by the electric heater 18, flows through the infusion circuit and heats it up.

The electronic controller 100 deactivates the pump 17 and the electric heater 18 when it acquires a temperature value T equal to the extraction start temperature value.

At this point, the thermoregulation phase ends.

The electronic controller 100 does not intervene on the shut-off valve 34, which remains open, but controls the closing of the discharge electro valve 37 to connect the infusion unit 11 to the dispensing conduit 32.

The electronic controller 100 sequentially controls the opening of infusion chamber 12, the loading of the powder coffee charge, and the closing of infusion chamber 12 without compression of the powder coffee charge.

At this point, the extraction phase begins.

The electronic controller 100 activates the pump 17 and the electric heater 18.

The infusion is carried out by keeping the shut-off valve 34 open and the discharge electro valve 37 closed.

Pump 17 is controlled by the electronic controller 100 in pulses depending on the type of aroma to be obtained, however ensuring a pressure in the region of 1 bar.

The electric heater 18 is controlled by the electronic controller 100 in such a way that the temperature detected by the sensor means 21 is essentially maintained at the value throughout the extraction phase.

As in the previous case, depending on the recipe selected via the machine/user interface, an amount of ice is recommended to be added to the product in the cup.

In this way, another type of ‘cold brew’ coffee can be obtained.

The extraction cycle is indicated by the letter B in FIG. 2, where to still indicates the instant at which the thermoregulation phase ends and the extraction phase begins.

### Case 4

Case 4 differs from the previous cases in that the T3 value of the extraction start temperature is set between 90° C. and 95° C.

Infusion unit 11 has the infusion chamber 12 empty, having previously ejected the spent coffee powder charge.

The infusion chamber 12 then connects the second connecting conduit 13 to the third connecting conduit 15.

When it acquires the recipe and identifies the extraction cycle associated with it, the electronic controller 100 opens the shut-off valve 34 to allow the bypass of the cream whipping valve 33 and opens the discharge electro valve 37 to allow the water to drain.

The electronic controller 100 acquires the value T of the temperature detected by the temperature sensor means 21 and, if the acquired value T is lower than the T3 value at the beginning of extraction, then it commands the activation of the electric heater 18 as well as of the pump 17 which draws water generally at room temperature from the water tank 14 or from the water mains so as to generate a flow of temperature control water which, after being heated by the electric heater 18, flows through the infusion circuit and heats it up.

The electronic controller 100 deactivates the pump 17 and the electric heater 18 when it acquires a temperature value T equal to the extraction start temperature T3.

At this point, the thermoregulation phase ends.

The electronic controller 100 does not intervene on the shut-off valve 34, which remains open, but controls the closing of the discharge electro valve 37 to connect the infusion unit 11 to the dispensing conduit 32.

The electronic controller 100 sequentially controls the opening of infusion chamber 12, the loading of the powder coffee charge, and the closing of infusion chamber 12 without compression of the powder coffee charge.

At this point, the extraction phase begins.

Electronic controller 100 activates the pump 17 but keeps the electric heater 18 switched off.

The infusion is carried out by keeping the shut-off valve 34 open and the discharge electro valve 37 closed.

Pump 17 is controlled by the electronic controller 100 in pulses depending on the type of aroma to be obtained, however ensuring a pressure in the region of 1 bar.

As the electric heater 18 is switched off, the measured temperature T will gradually move towards the room temperature during delivery.

Depending on the recipe selected via the machine/user interface, an amount of ice is recommended to be added to the product in the cup.

In this way, another type of ‘cold brew’ coffee can be obtained.

The extraction cycle is indicated by the letter C in FIG. 2, where to still indicates the instant at which the thermoregulation phase ends and the extraction phase begins.

### Case 5

Case 5 differs from case 1 in the extraction phase, which is performed with shut-off valve 34 closed so that the first high-pressure exit path 27 is selected instead of the second low-pressure exit path 28.

In this way, another type of ‘cold brew’ coffee can be obtained.

### Case 6

Case 6 differs from cases 2 and 3 in the extraction phase, which is performed with shut-off valve 34 closed so that the first high-pressure exit path 27 is selected instead of the second low-pressure exit path 28.

In this way, another type of ‘cold brew’ coffee can be obtained.

### Case 7

Case 7 differs from case 4 in the extraction phase, which is performed with shut-off valve 34 closed so that the first high-pressure exit path 27 is selected instead of the second low-pressure exit path 28.

In this way, another type of ‘cold brew’ coffee can be obtained.

All of the above extraction cycles can provide for drying of the spent coffee charge by squeezing it. In particular, the electronic controller 100 can order a relative approaching movement between the piston 25 and the body 24 and the liquid extracted from the spent coffee charge can be conveyed towards the discharge conduit 36 by simply switching the discharge electro valve 37.

The coffee machine 10 can versatilely perform other types of extraction cycles as well, e.g. an extraction cycle involving a compression of the coffee charge between the piston 25 and the body 24 of the infusion chamber 12, and the execution of the extraction phase with an extraction start Ti value between 90° C. and 95° C. maintained during the entire extraction phase, with the pump operating at high pressure, e.g. at least 6 bar, and the shut-off valve 34 closed to extract an espresso coffee.

More generally, in at least one extraction cycle, it can be envisaged that the extraction phase is carried out with the electric heater 18 activated for maintaining the extraction start temperature, as illustrated for example in cases 2 and 6 above, or that the extraction phase is carried out with the electric heater 18 deactivated for the gradual descent of the extraction start temperature, as illustrated for example in cases 4 and 7 above.

In general, as mentioned above, in an extraction cycle, pump 17 is controlled by the electronic controller 100 with pulses depending on the type of flavour to be obtained, and can operate at various pressure and flow levels depending on the extraction cycle.

As mentioned, each extraction cycle includes a dedicated temperature control phase of the infusion circuit and a dedicated coffee extraction phase with a specific Ti value of a coffee extraction start temperature.

The dedicated extraction phase, for all extraction cycles, provides for a specific quantity of extracted coffee and a specific extraction profile that involves repeating identical activation cycles of the supply pump 17 until the specific quantity of extracted coffee is reached.

The cycles each consist of an on time and an off time for the supply pump 17.

The on time can be the same or different from the off time.

Of course, the number of repeated cycles depends on the extraction cycle selected.

The dedicated extraction phase may sequentially comprise a coffee-infusion sub-phase in which the supply pump 17 fills the infusion chamber 12 with water, and an actual infusion sub-phase until the specific amount of extracted coffee is reached.

Supply pump 17 is preferably programmed for pulsed delivery.

Preferably, the supply pump 17 activation cycle does not differentiate between the wetting sub-phase and the actual dispensing sub-phase, which are performed by repeating the same cycle consisting of an on time and an off time.

FIGS. 3a, 3b show some graphs exemplifying the cyclic activation mode of the supply pump 17 during the extraction phase of various extraction cycles.

In the graphs shown in FIGS. 3 a, 3 b, the abscissas represent the time t between the instant t(o) of the start of the extraction phase and the time t_{(f)} of the end of the extraction phase, while the ordinates represent the electrical activation signal Ap of the supply pump 17.

As can be seen, the dispensing sub-phase and the previous wetting sub-phase are performed with a pulse activation of the supply pump.

In FIG. 3 a, the on time is equal to a, the off time is also equal to a, and consequently the cycle period is equal to 2a.

In FIG. 3 b the on time is equal to b, the off time is equal to c, and consequently the cycle period is equal to b+c.

Preferably, if the on time is different from the off time, then the on time is greater than the off time.

According to the invention, preferably the dispensing sub-stage is performed by repetition of a plurality of cycles having an off time of no more than 10 sec, an on time of no more than 10 sec, and an average flow rate dispensed by the supply pump 17 of between 2 cc/sec to 6 cc/sec.

According to the invention, preferably also the sub-stage of wetting is performed with an off time of no more than 10 sec, on time of no more than 10 sec, and average flow rate delivered by the supply pump 17 between 2 cc/sec to 6 cc/sec.

For example, the dispensing sub-phase is performed by repetition of a plurality of cycles with an off time between 0.5 sec and 10 sec, on time between 0.5 sec and 10 sec, and average flow rate delivered by the supply pump 17 between 2 cc/sec and 6 cc/sec.

And similarly, the wetting sub-stage is performed with an off time between 0.5 sec and 10 sec, on time between 0.5 sec and 10 sec, and average flow rate delivered by the supply pump 17 between 2 cc/sec and 6 cc/sec.

The off times of supply pump 17 can also be very short when the selected recipe is compatible with the nominal flow rate of supply pump 17.

For example, in this case, supply pump 17 off times can be assumed to be 1/50 seconds or 1/60 seconds and the on times can be equal to the off times.

Modifications and/or additions of parts may be made to the described coffee machine and extraction method without departing from the scope of the present invention as defined by the claims.

1. A method for extracting coffee with a coffee machine comprising an infusion circuit at least including a water tank or a connection to a water source, a supply pump, an electric heater and an infusion unit having an infusion chamber where a load of coffee powder can be positioned, connected in sequence, wherein said machine memorizes a plurality of selectable extraction cycles, where each extraction cycle includes a step dedicated to the heat regulation of the infusion circuit before the positioning of the load of coffee powder and subsequently a step dedicated to the extraction of coffee having a specific coffee extraction start temperature value, where the dedicated extraction step further envisages a specific amount of coffee extracted and a specific extraction profile which envisages the repetition of identical activation cycles of the supply pump until reaching the specific amount of extracted coffee, where the cycles are each formed by an on time and an off time of the supply pump, and where the coffee machine, after having acquired a coffee extraction cycle selection, detects the temperature value along the infusion circuit, compares said detected temperature value with the extraction start temperature value of the selected extraction cycle, performs the heat regulation step by activating the supply pump and, if necessary, the electric heater, for generating a heat regulation water flow until said detected temperature value reaches said extraction start temperature value of the selected extraction cycle, and performs the extraction step cyclically by activating the supply pump and by activating the electric heater at least when an extraction cycle is selected which envisages maintaining or increasing the extraction temperature from the extraction start temperature value.

2. The coffee extraction method according to claim 1, wherein it comprises a plurality of extraction cycles including an extraction cycle which envisages an extraction start temperature value comprised between 25° C. and 50° C., an extraction cycle which envisages an extraction start temperature value comprised between 50° C. and 60° C. and an extraction cycle which envisages an extraction start temperature value comprised between 90° C. and 95°C.

3. The coffee extraction method according to claim 1, wherein said supply pump is programmed for pulsed dispensing.

4. The coffee extraction method according to claim 1, wherein the on time is equal to the off time.

5. The coffee extraction method according to claim 1, wherein the on time is different from the off time.

6. The coffee extraction method according to claim 1, wherein the off time is not longer than 10 sec, the on time is not longer than 10 sec, and said supply pump dispenses in said extraction step an average flow rate comprised between 2 cc/sec and 6 cc/sec.

7. The coffee extraction method according to claim 1, wherein said coffee machine detects said temperature value at an inlet or at an outlet of said electric heater.

8. A coffee machine comprising an electronic controller, an infusion circuit at least including a water tank or a connection to a water source, a supply pump, an electric heater and an infusion unit having an infusion chamber where a load of coffee powder can be positioned, connected in sequence, wherein the electronic controller memorizes a plurality of selectable extraction cycles, where each extraction cycle includes a step dedicated to the heat regulation of the infusion circuit before the positioning of the load of coffee powder and subsequently a step dedicated to the extraction of coffee having a specific coffee extraction start temperature value, where the dedicated extraction step further comprises a specific amount of coffee extracted and a specific extraction profile which envisages the repetition of identical activation cycles of the supply pump until reaching the specific amount of extracted coffee, where the cycles are each formed by an on time and an off time of the supply pump, and in that said electronic controller is programmed to acquire a coffee extraction cycle selection, detect the temperature value along the infusion circuit, compare said detected temperature value with the extraction start temperature value of the selected extraction cycle, control the performance of the heat regulation step by activating the supply pump and, if necessary, the electric heater, for generating a heat regulation water flow until said detected temperature value reaches said extraction start temperature value of the selected extraction cycle, and control the performance of the extraction step cyclically by activating the supply pump and by activating the electric heater at least when an extraction cycle is selected which envisages maintaining or increasing the extraction temperature from the extraction start temperature value.

9. The coffee machine according to claim 8, wherein said modular electric heater consists of an instantaneous boiler.
